(19) United States
(12) Patent Application Publication
(10) Pub. No.: US 2009/0139664 A1
(43) Pub. Date: Jun. 4, 2009

(54) Blind with Pockets

(76) Inventor: Claus Graichen, Henderson, NC (US)

Correspondence Address: COATS & BENNETT, PLLC, 1400 Crescent Green, Suite 300, Cary, NC, 27518, US

(21) Appl. No.: 11/948,471

(22) Filed: Nov. 30, 2007

(51) Int. Cl. E06B 9/24; E06B 9/00; E06B 9/26

(52) U.S. Cl. 160/84.04; 160/230; 160/236

(57) ABSTRACT

A vertical blind comprising a single fabric sheet having a series of vertical panels. The vertical panels include at least one relatively translucent panel and a plurality of vertical pocket panels. Each vertical pocket panel includes a vertical pocket. A vane is disposed and contained within the pocket for moving the associated pocket panel between open and closed positions. The vertical pocket panel along with the vane form a relatively opaque panel such that the vertical blind includes relatively translucent and relatively opaque panels.

### FIELD OF THE INVENTION

The present invention relates to vertical blinds for use in window treatments.

### BACKGROUND

Vertical blinds typically comprise a series of elongated panels suspended vertically from a support assembly. The support assembly generally includes a frame or track within which hangers are disposed. The panels are suspended by attaching panels to hangers. The hangers are typically operable to both rotate the panels about the long axes thereof and to translate the panels along the frame or track. When the panels are rotated to one extreme, the panels generally align with line of sight such that the blinds are open and allow light to pass through. When the panels are rotated to an opposite extreme, the panels generally extend normal to the line of sight and slightly overlap one another such that the blind is closed.

Such vertical blinds can be rather plain in appearance and have limited capability to provide soft effects in controlling visibility therethrough. The use of cloth drapery-like structures in association with blinds have provided improvements in appearance and softening of light control. However, the support of such drapery-like structures is sometimes problematic and operability of the window treatment provided is often cumbersome.

### SUMMARY OF THE INVENTION

A vertical blind is provided and includes a fabric having a series of vertical panels. The vertical panels include a series of vertical pocket panels, each pocket panel including a pocket. A vane is disposed and contained within respective pockets and function to move the associated pocket panel between open and closed positions.

Other objects and advantages of the present invention will become apparent and obvious from a study of the following description and the accompanying drawings which are merely illustrative of such invention.

### BRIEF DESCRIPTION OF THE DRAWINGS

FIG. 1 is front view of a vertical blind showing the fabric, panels and vanes.

FIG. 2 is a top view of a portion of a vertical blind.

FIG. 3 is a fragmentary front elevation of a U-type vertical blind in the open position.

FIG. 4 is a fragmentary top view of the U-type vertical blind in the open position.

FIG. 5 is a fragmentary top view of the U-type vertical blind in the closed position.

FIG. 6 is a fragmentary front elevation of the S-type vertical blind in the open position.

FIG. 7 is a fragmentary top view of the S-type vertical blind in the open position.

FIG. 8 is a fragmentary top view of the S-type vertical blind in the closed position.

FIG. 9A is a fragmentary perspective view of a segment of the vertical blind.

FIG. 9B is a fragmentary perspective view of the vertical blind configured as a series of segments.

FIG. 10 is a top view of a portion of a vertical blind formed using adjacently suspended segments to form the U-type vertical blind.

FIG. 11 is a top view of a portion of a vertical blind formed using adjacently suspended segments to form the S-type vertical blind.

FIG. 12 is a fragmentary side elevation cross-sectional view of a pocket panel supported by a hanger.

FIG. 13 is a fragmentary front elevation of a pocket panel showing an alternate embodiment.

FIG. 14 is a front elevation of a vertical blind formed from a combination of segments to form U-type and S-type portions in the same vertical blind.

FIG. 15 is a fabric construction for a woven vertical blind.

FIG. 16 is a fabric construction for a warp knitted vertical blind.

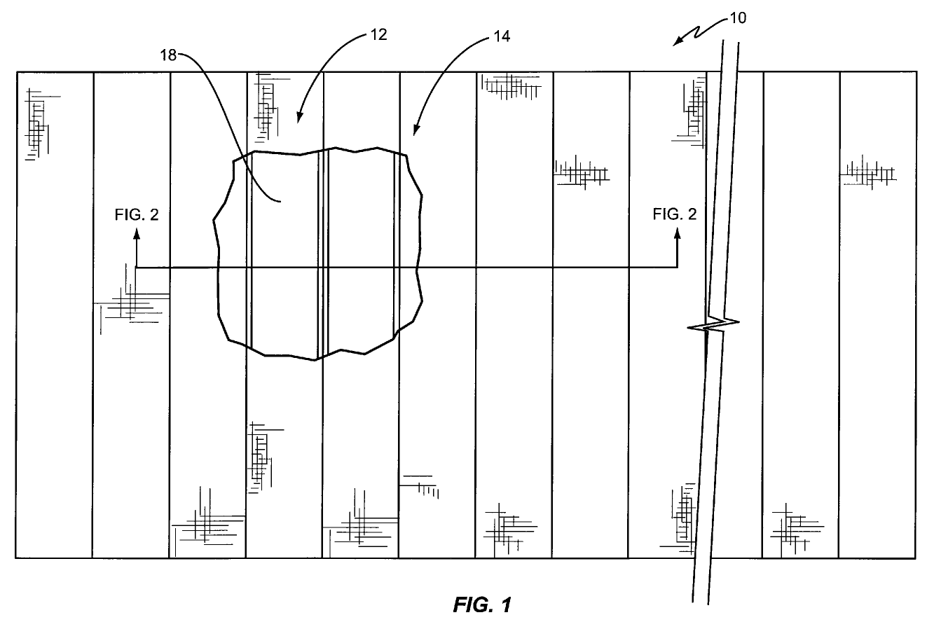

### DETAILED DESCRIPTION

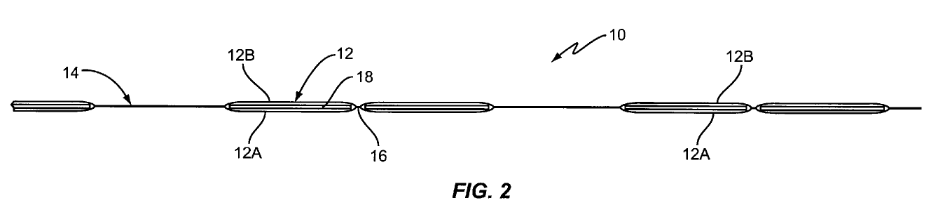

With further reference to the drawings, the present invention provides a vertical blind, indicated generally by the numeral 10. Vertical blind 10 comprises a fabric having a plurality of vertical panels. As used herein, the term “vertical blind” refers to a blind having a plurality of elongated panels that when the blind is hung, extend vertically adjacent an opening, such as a window, in a building. The term “vertical panel” as used herein refers to an elongated portion of a vertical blind that extends generally vertical in the blind when the blind is hung. The vertical panels include pocket panels 12 and panels 14. In a preferred embodiment the fabric is a single sheet of fabric with panels 12 and 14 formed in the single fabric sheet. The term “single fabric sheet” or “fabric sheet” means a fabric structure that comes out of a weaving or knitting machine as a single unit. In one embodiment the panels 14 that comprise a part of the vertical blind 10 are non-pocket panels or include a layer of fabric that does not include an opening for receiving a vane or other similar structure. In one embodiment, the fabric includes one panel 14 interposed between two pairs of pocket panels 12. In this embodiment, each pocket panel in a pair is connected to the other pocket panel in the pair by a hinge 16. See FIG. 2.

Forming a part each pocket panel 12 is a vertical pocket. A plurality of vanes 18 is provided and the vanes are contained in pockets. Each vane 18 forms an elongated member that is relatively stiff and substantial as compared to the fabric. Vanes 18 may be comprised of wood, plastic, cardboard, heavy and stiff or starched fabrics, or any other material that forms a relatively stiff elongated member that is capable of moving the pocket panels 12. In cross section, vanes 18 may be flat, ovate, or curved.

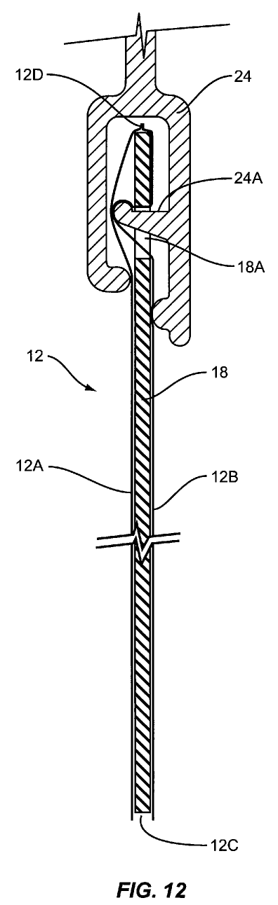

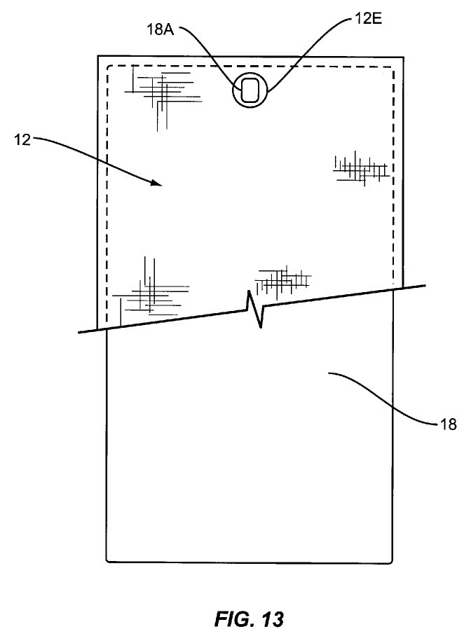

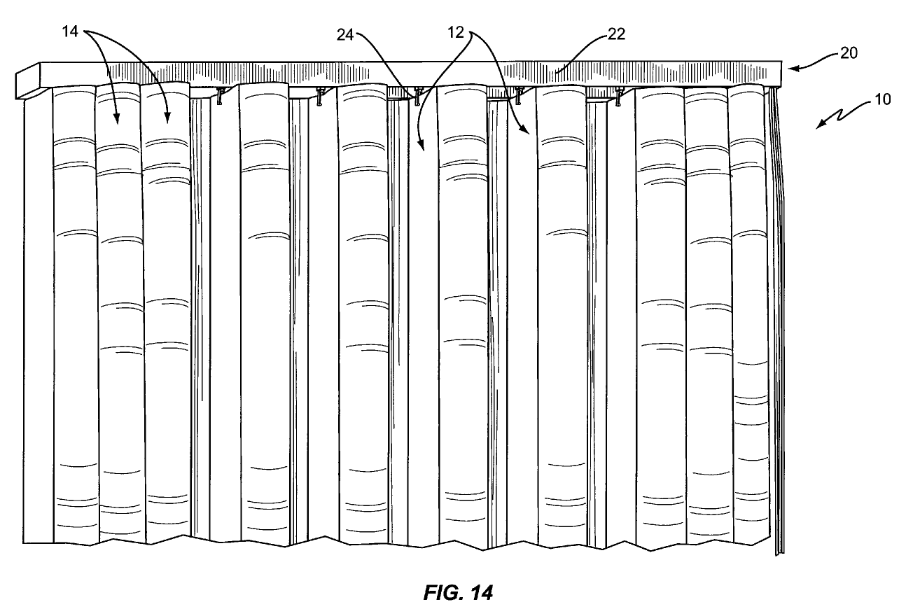

Vertical blind 10 is adapted to be suspended from a support assembly 20. Support assembly is of conventional design, and the details thereof will not be addressed herein. Generally, support assembly 20 includes a frame 22 and a series of moveable hangers 24 as illustrated in FIG. 14. In one embodiment, vanes 18 may include openings 18A for receiving hangers 24 as illustrated in FIGS. 12 and 13.

In one embodiment, the panels of vertical blind 10 may vary in light transmissibility. In one embodiment, panels 14 are designed to be relatively translucent. For example, panels 14 may be of a woven or knitted sheer construction. The other panels, or pocket panels 12, may be relatively opaque. The relative opacity may be provided by the manner of construction of the pocket panels 12 themselves, by the vane 18, or by a combination of the pocket panels and the vanes.

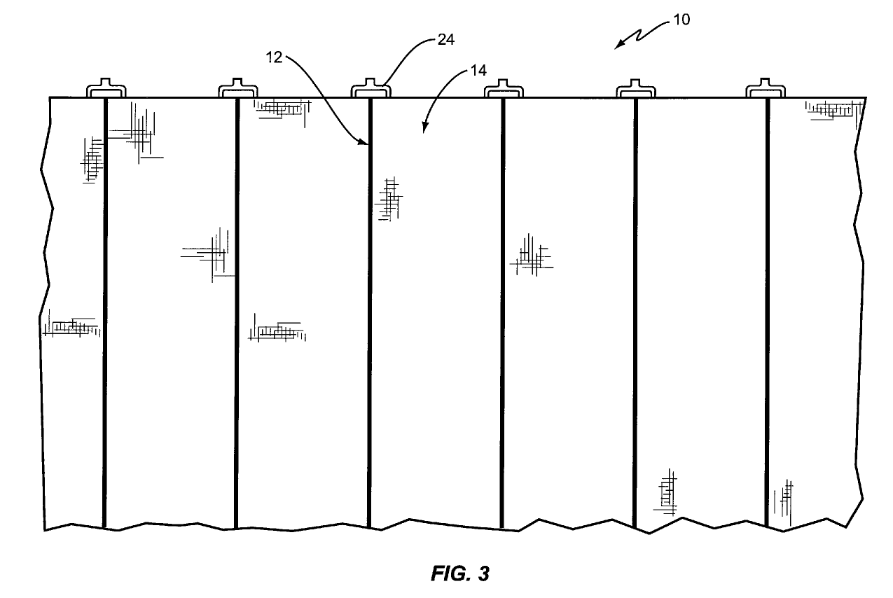

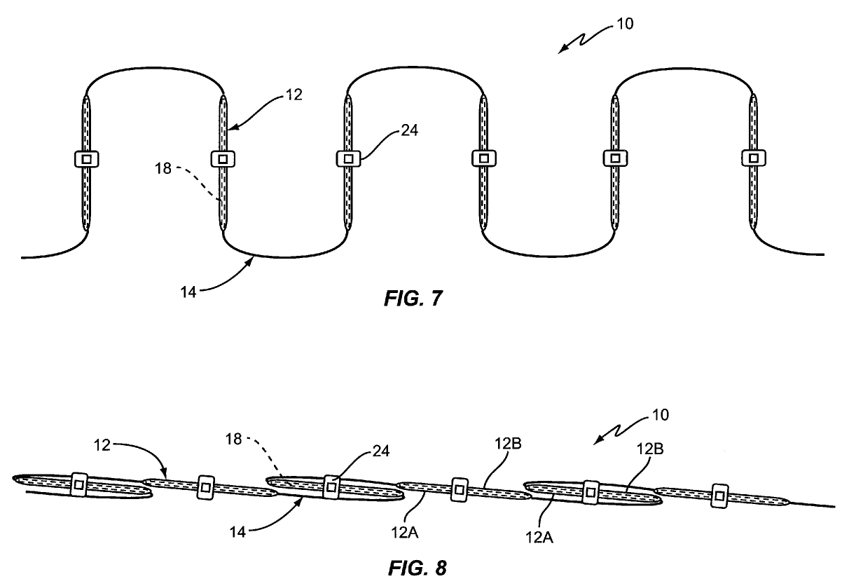

Vertical blind 10 may assume open, closed, and various intermediate positions. For example, when applied to a window in a building, vertical blind 10 may be open to permit some light transmission there through as illustrated in FIGS. 3, 4, 6, and 7. Vertical blind 10 may be closed to generally diminish or prevent light transmission there through. See FIGS. 5 and 8. To provide an intermediate level of light transmission, vertical blind 10 may be positioned in one or more various intermediate positions. Vertical blind 10 can thus be constructed and positioned to provide light transmission into a space, subdued or dimmed light into a space, or substantial darkening of a space.

Generally, in the open configuration or position, the pocket panels 12 are oriented approximately perpendicular to the window surface while panels 14 are oriented somewhat in a parallel fashion to the window. In a closed position, the pocket panels 12 are moved to generally align with and extend along the non-pocket panels 14. In the closed position, pocket panels 12 thus abut or partially overlap adjacent pocket panels across vertical blind 10 to close the blind.

In one embodiment, the panels 12, 14 may have a variety of decorative surface features that display differently depending on the position of vertical blind 10. For example, in an open configuration, panels 14 predominate the front view of vertical blind 10, and any pattern or color of panels 14 is generally fully displayed. In a closed or intermediate position, decorative surface features of the pocket panels 12 will be visible and will provide a different decorative display.

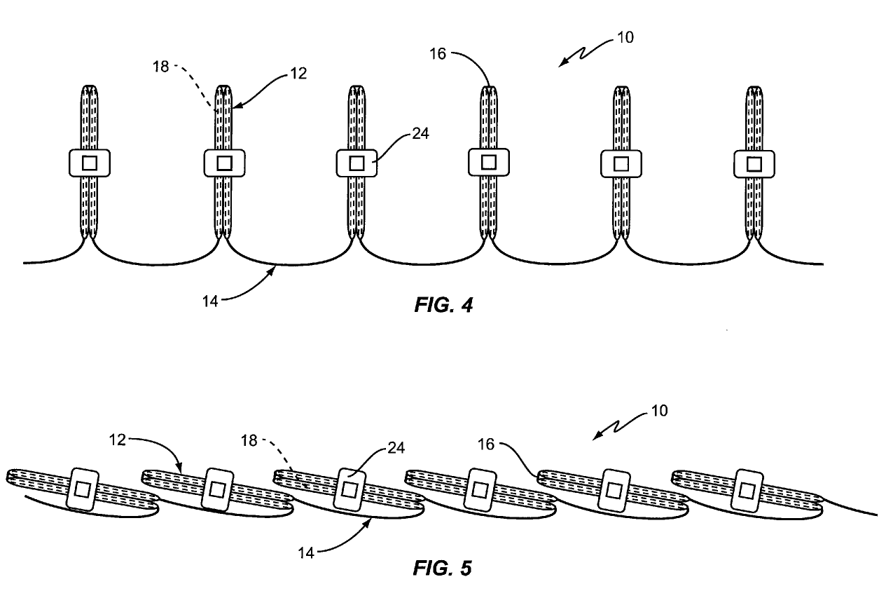

In one embodiment, the fabric comprising vertical blind 10 includes at least two pairs of pocket panels 12 with at least one panel 14 interposed between the two pairs of pocket panels as best illustrated in FIGS. 4 and 5. This embodiment illustrates the U-type of configuration of vertical blind 20. In the open configuration applied to a window, panels 14 are bowed and generally parallel with the window. See FIG. 4. The bowed panels 14 may, in one embodiment, be relatively near the window and bowed towards the window or they may be spaced relatively apart from the window and bowed away from the window. The panels of each pair of pocket panels 12 extend along each other and are generally normal to the window surface such that vertical blind 10 exhibits the form of a series of adjacent “U” shapes. In the closed configuration, illustrated in FIG. 5, the pairs of pocket panels 12 are rotated by turning hangers 24 such that the pocket panels generally extend along panels 14 and abut or slightly overlap adjacent pocket panels.

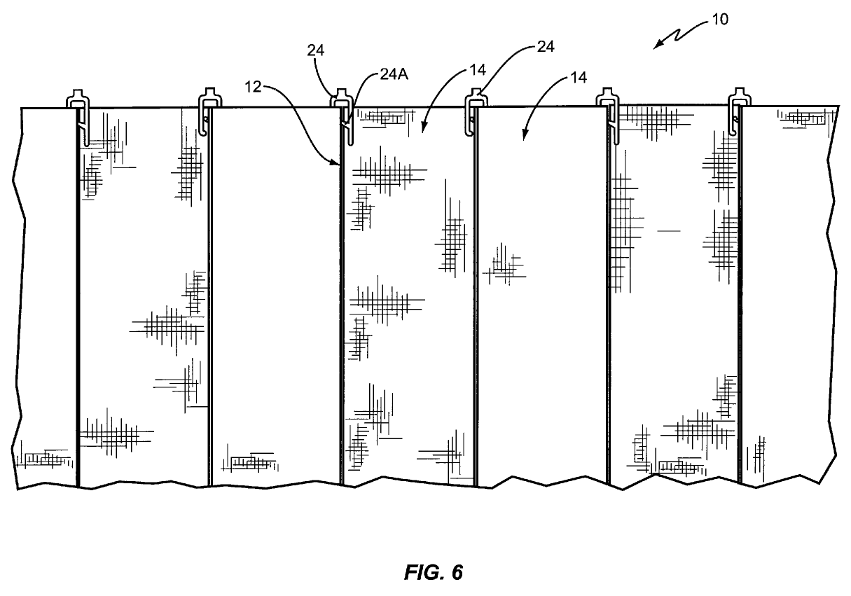

In one embodiment the fabric of vertical blind 10 comprises alternate pocket panels 12 and panels 14 as illustrated in FIGS. 6, 7, and 8. This embodiment illustrates the S-type configuration of vertical blind 10. When suspended adjacent a window, for example, vertical blind 10 in the open configuration has pocket panels 12 oriented generally normal to the window surface, or generally in line with line of sight.

Panels 14 are generally facing the window, with each panel 14 forming a bow. Some panels 14 are thus relatively far from the window while alternate panels are relatively near the window. Vertical blind 10 thus assumes the form of a series “S” shaped portions. Panels 14 may be, in one embodiment, relatively translucent such that substantial light transmission is enabled through vertical blind 10 when in the open configuration. In one embodiment, panel 14 comprises relatively sheer or light-weight construction to enable relative translucence. Additionally, pocket panels 12 may be relatively opaque. In one embodiment, pocket panels 12 comprise relatively dense or heavy-weight construction to enable relative opacity. In the closed configuration, pocket panels 12 are rotated by turning hangers 24 such that the pocket panels generally align with panels 14 with alternate pocket panels being sandwiched between panels 14 as shown in FIG. 8. Pocket panels 12 generally abut or slightly overlap each other to close vertical blind 10.

The fabric of vertical blind 10 may be formed with a varying pattern of pocket panels 12 and panels 14. In one embodiment, a part of the fabric may comprise one or more U-type portions while another part of the fabric may include one or more S-type portions. Various combinations and placements of S-type and U-type portions may be formed in the fabric to provide various appearances. For example, vertical blind 10 may comprise a group of U-type portions forming side borders with a group of S-type portions forming a central section as shown in FIG. 14. Vertical blind 10 may thus be comprised of a single fabric so as to extend continuously over a substantial horizontal width covering, for example, a window or opening in a building.

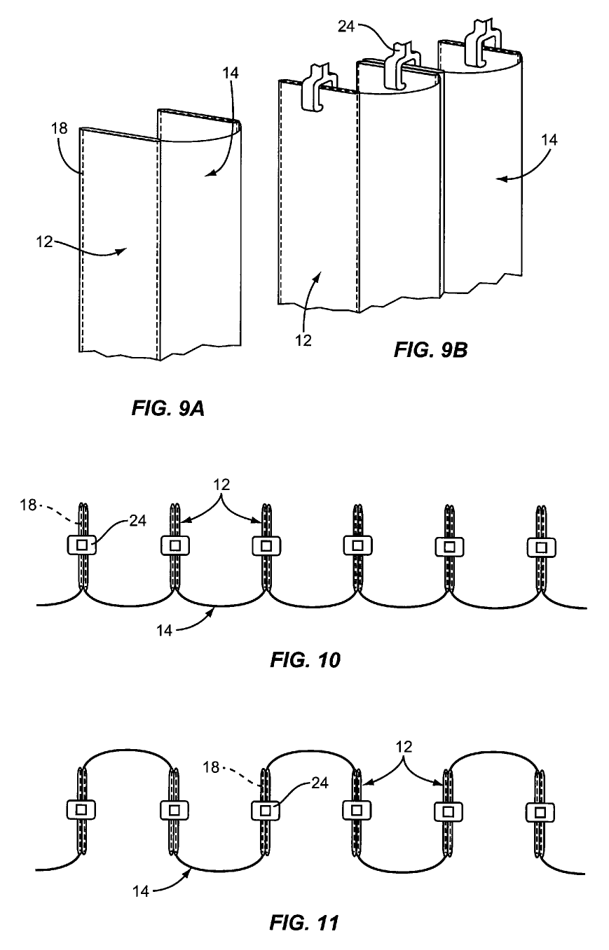

Vertical blind 10 may, in one embodiment, comprise a series of separate segments of fabric. A separate segment may comprise two pocket panels 12 and one panel 14 to form a segment as illustrated in FIG. 9A. Multiple segments may be suspended alongside each other to form a U-type portion of vertical blind 10 as seen in FIG. 9B and further illustrated in FIG. 10. Alternatively, the segments may be juxtaposed in an S-type arrangement as shown in FIG. 11. Thus, various combinations of S-type portions and U-type portions may make up vertical blind 10 by suspending together such segments.

Turning now to a more detailed consideration of the pockets formed by pocket panels 14 of the fabric, each pocket extends along a substantial portion of one of the pocket panels. A pocket is comprised of first and second layers 12A, 12B. Layers 12A, 12B are adjacently disposed, the longitudinal edges thereof being connected together to form the pocket. In one embodiment, a lower end 12C of the pocket is open to permit insertion of vane 18 as illustrated in FIG. 12. In this embodiment, an upper end of the pocket is closed, partially closed, or sealed by connecting together top edges of layers 12A, 12B forming a closure 12D. It is appreciated that pocket panel 12, and thus the fabric of vertical blind 10 is supported by vane 18 when the vane is suspended from hanger 24 as illustrated in FIGS. 13 and 14. It is further appreciated that the support is provided by closure 12D. Closure 12D may be a seam formed by sonic or laser welding, for example, opposed portions of the upper edges of layers 12A, 12B. Closure 12D may be a continuous seam or a series of spaced apart seam segments or other connections between the upper edges of layers 12A and 12B. However configured, closure 12D interacts with vane 18 so that hanger 24 supports the vane 18 and the vane supports the fabric of vertical blind 10 as illustrated in FIG. 12.

Considering now the ways of connecting vertical blind 10 to hangers 24 of support 20, in one embodiment layers 12A and 12B may be continuous over pocket panel 12 as illustrated in FIG. 12. In such cases, the fabric is sufficiently compliant such that stub 24A may distort the fabric and penetrate opening 18A of vane 18. In another embodiment, an opening 12E may be provided in layers 12A, 12B as shown in FIG. 13. Various shapes and ways of making opening 12E may be practiced. Opening 12E may be in the form of a pair aligned holes the upper portion of layers 12A, 12B as illustrated. Alternatively, opening 12E may be a continuous opening extending across the upper ends of layers 12A, 12B and downwardly on both layers. Opening 12E may be formed in the manufacture of the fabric or it may be formed by burning or cutting the manufactured fabric. However formed, opening 12E permits stub 24A to pass through the opening to penetrate opening 18A of vane 18 such that hanger 24 supports the vane.

An alternative way of connecting vertical blind 10 to hangers 24 includes use of an adapter of common design which may be adhered to the upper portion of one or more pocket panels 12. In one embodiment of the U-type configuration, the adapter clips over and is secured to top, or outer, pocket layers 12A of adjacent pocket panels. In one embodiment, the adapter is secured to pocket layers 12a, 12B by adhesion or welding such as by sonic welding. In one embodiment of the S-type configuration, the adapter clips over and is secured to pocket layers 12A, 12B of one of the pocket panels 12. The adapter includes an opening similar to opening 18A in vane 18 for receiving stub 24A of hanger 24. In each of the foregoing embodiments, vanes 18 are supported within the pockets. In one embodiment vanes 18 may be supported by the lower ends of the pockets being at least partially closed. In one embodiment, the adapter compresses the panel or panels over which it clips sufficiently to support the panels by friction. In one embodiment the adapter may include appurtenances to at least partially penetrate the panel or panels to engage and hold the panels such that the ends of the pockets may be open or closed.

Turning now to the manufacture of vertical blind 10, the blind may be formed by various methods forming single sheets of fabric having pockets. In one embodiment the fabric is formed by weaving where the pockets of are integrally formed using techniques known to those of ordinary skill in weaving. In another embodiment a warp-knitted fabric is formed having panels wherein the pockets are integrally knitted into pocket panels 12 of the fabric using techniques known to those of ordinary skill in warp knitting.

In one embodiment, vertical blind 10 may be manufactured in a width-for-length form by a weaving process, for example, on a Jaquard Loom. In this embodiment, the length (vertical dimension) of vertical blind 10 is limited by the width of the weaving machine employed. The panels are formed in any desired sequence to produce vertical blind 10 with S-type, U-type, or combination features. It is sufficient to describe the formation of one panel 14 followed by an adjacent pocket panel 12.

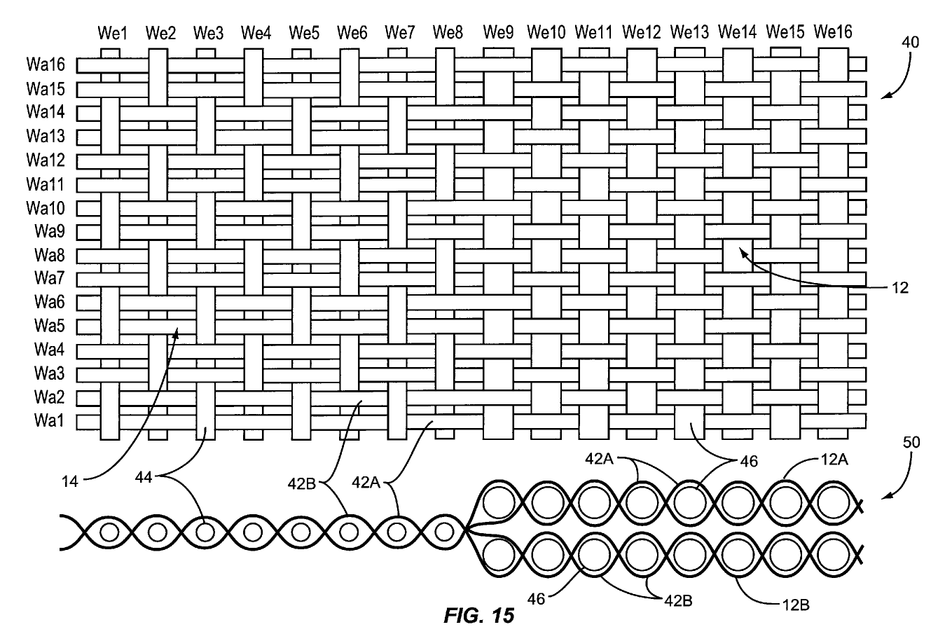

FIG. 15 illustrates the structure of a portion of the fabric for vertical blind 10 as woven. Reference 40 generally indicates the construction of the fabric, showing sixteen warps Wa1-Wa16 and sixteen wefts We1-We16 of the fabric. The fabric portion shown comprises a part of one of the panels 14 alongside a part of one of the pocket panels 12. For purposes of reference, panel 14 is referred to as a non-pocket panel. The non-pocket portions shown extend over wefts We1 to We8, and the pocket portion shown extends over wefts We9 to We16. The fabric is formed using a warp yarns 42A, 42B and first and second weft yarns 44, 46. Second weft yarn 46 is sometimes referred to as the pocket yarn. Warp yarns 42A,42B are warped in pairs, two up-two down to form non-pocket panel 14. For example, warp yarns 42A, 42B in warps Wa3, Wa4 pass side-by side over first weft yarn 44 in weft We1, under yarn 44 in weft We2, over yarn 44 in weft We3, and so on until weft We9 to form part of non-pocket panel 14. Thence, warp yarn 42A passes over pocket yarn 46 in weft We9, under pocket yarn 46 in weft We10, over pocket yarn 46 in weft We 11 and so on. Likewise, warp yarn 42A in warp Wa5 passes under and over pocket yarns 46 in wefts We9 and following wefts in opposition to the yarn in warp Wa3 to form one layer 12A of the pocket as shown in side view 50 of FIG. 15. After weft We8, warp yarn 42B interacts similarly with pocket yarns 46 to form layer 12B of the pocket.

In one embodiment, where non-pocket panel 14 is a relatively translucent or light-weight panel and pocket panel 12 is a relatively opaque or heavy-weight. First weft yarn 44 may be substantially smaller and lighter than the second weft or pocket yarn 46. Warp yarns 42A, 42B are generally identical to each other and, of course, continuous across all panels. A typical yarn selection for one embodiment is presented in a Table I.

TABLE I

| Warp Yarns 40A, 40B | 2 ends 20 denier monofilament poly full dull |
|---|---|
| | 14.5 turns Z |
| First Weft Yarn 42 | 3 ends 15 denier monofilament bright trilobal |
| | poly 10 turns Z. |
| Second Weft (Pocket) Yarn | 1 end 400 denier spun yarn |
| 44 | |

The length of the panels, and thus of vertical blind 10, is determined for the particular application. This length, however, may be limited by the width of the weaving machine when the fabric is woven in a length-for-width arrangement as is the usual case. Typical maximum length is about 118 inches (300 cm). The width of the panels may likewise be variable. However, an exemplary panel width is about 4 inches (10.2 cm). In the case of pocket panels 12, the inside width of the pocket is generally about 3.75 inches (9.5 cm) to accommodate vanes 18 having a width of about 3.5 inches (8.9 cm). Where hinges 16 are required, as between adjacent pocket panels 12 in one embodiment of the U-type configuration, the hinges are typically about 3/16 inches (0.5 cm) wide and formed similarly to non-pocket panels 14. It is appreciated that alternative lengths and widths may be employed for various applications.

Where the fabric is to be cut into separate segments, for example including two pocket panels 12 and one panel 14, a transition portion may be woven connecting the panels 12 and 14. This transition portion may include a narrow strip running longitudinally alongside the pocket where a heavier first warp yarn 44 may be used. This transition portion is generally about ⅛ inch (0.3 cm) wide and may serve as a cutting guide for cutting the segments from the fabric.

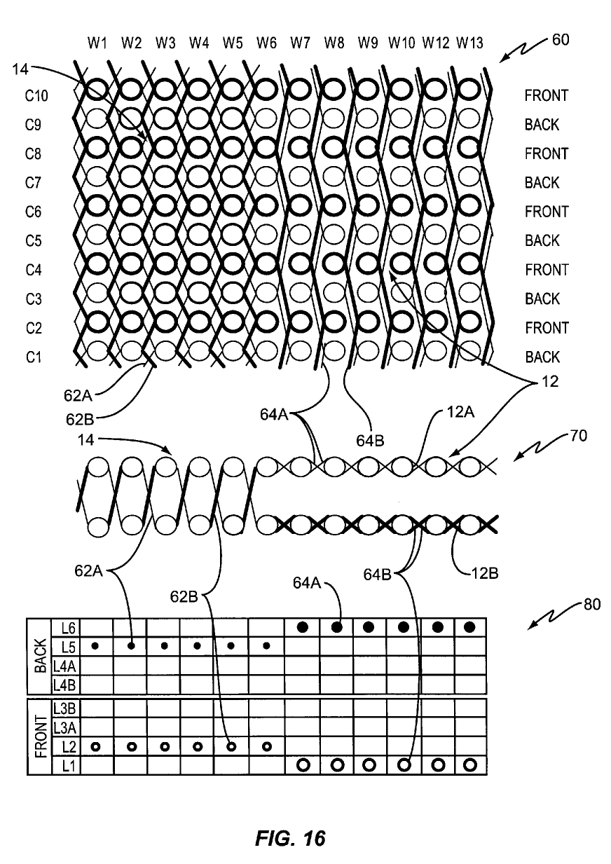

Vertical blind 10 may also be formed by a knitting process on a Double Needle Bar Raschel Machine with a Piezo-Jacquard System such as the Nippon Mayer RDPJ 6/2. The warp knit construction of the fabric for vertical blind 10 is illustrated in FIG. 16. A construction diagram 60 indicates the series of instantaneous needle locations and stitching to form the fabric, illustrating a portion of the fabric defined by courses C1-C10 and wales W1-W13. A portion of one of the panels 14 is shown alongside a portion of one of the pocket panels 12. A side view 70 of the fabric shows a portion of a pocket formed between layers 12A, 12B. A threading diagram 80 shows guide bars for front and back needle bars of the RDPJ 6/2 labeled respectively “FRONT” and “BACK”. The fabric sheet is knitted utilizing a first group of yarns 62A, 62B fully threaded in guide bars L2 and L5 to form panels 14. A second group of yarns 64A, 64B, sometimes called pocket yarns, is fully threaded in guide bar L1 and L6 to form pocket panels 12. In one embodiment, yarns 64A, 64B are heavier, or of a higher denier, than yarns 62A, 62B. The fabric is formed using closed tricot stitches in a manner known to those of ordinary skill in warp knitting.

Generally, to form panel 14, yarns 62A, 62B form closed tricot stitches that run up course from one course to the next connecting adjacent wales. It is appreciated that the double needle bar of the RDPJ 6/2 can produce a fabric sheet that encompasses two parallel planes, a back plane associated with the back needle bar and the front plane associated with the front needle bar. However, the needles may deflect to tie stitches between planes as illustrated in the left hand portion of side view 70 in FIG. 15. More particularly, for example, yarn 62A executes a closed tricot stitch at course C1—wale W3 in the back plane. Yarn 62A then laps to from a closed tricot stitch at course C2—wale W2 in the front plane, and so forth. Yarn 62B executes a closed tricot stitch at course C1—wale W2 in the back plane and laps to course C2—wale W3 in the front plane and so forth. The yarns thus alternate from wale to adjacent wale and from back plane to front plane to form panels 14 as illustrated in side view 70.

To form pocket panels 12, the yarns do not alternate between planes. Rather, yarns 64A form layer 12A in the back plane by closed tricot stitches connecting adjacent wales, and yarns 64B form layer 12B in the front plane similarly by making close tricot stitches connecting adjacent wales. For example, yarn 64A executes a closed tricot stitch at course C1—wale W8 in the back plane and, remaining in the back plane makes a tricot stitch at course C3—wale W7 to form layer 12A. Yarn 64B, for example, forms a closed tricot stitch at course C2—wale W9 in the front plane and, remaining in the front plane makes a tricot stitch to course C4—wale W8, and so forth. In this manner layers 12A and 12B of the pocket are formed as illustrated in side view 70.

Yarns of the first group 62A, 62B may be identical to yarns of the second group 64A, 64B. As has been noted, however, the two groups of yarns may differ. For example, when it is desired to provide a relatively sheer or light-weight panel 14 and a relatively heavy-weight pocket panel 12 yarns 64A, 64B may be heavier yarns than yarns 62A, 62B. A typical yarn selection for one embodiment of vertical blind 10 is given in Table II below.

TABLE II

| | |
|---|---|
| Yarns 62A, 62B | 2 ends 20 denier monofilament poly full |
| | dull 14.5 turns Z |
| Yarns 64A, 64B (pocket yarns) | 1 end 70 denier 34 filament tex. yarn |

As is the case with a woven vertical blind 10, the length of the panels is determined for the particular application. However, in the case of knitted vertical blind 10 the length has no practical limit. This is true because knitting of the sheet of fabric comprising vertical blind 10 is done in a length-for-length arrangement.

To provide structural substance to panel 14, for example when the panel is of a sheer or light-weight construction, the fabric may be heat set to at least partially fuse warp and weft yarns. This fusing by heat setting stabilizes the fabric sheet and adds to the ability of the fabric sheet to maintain shape. Maintaining shape assists in forming and holding a bow in sheer non-pocket panels 14 when vertical blind 10 is not closed.

Where required, and whether formed by weaving, knitting, or other fabrication method, ends of pockets are closed to form closure 12D. Further, depending on the method of manufacture, selvages may be formed and required to be cut off. Also, in forming segments which can be assembled into blinds as described here before, fabric or sheet material is required to be precisely cut. Generally, using heat provided in various forms provides the sealing and cutting functions required. For example a sonic cutter or laser cutter may be used to cut the fabric or sheet. Such cutters function by passing a cutter head along the fabric at a pre-determined speed. Energy from the cutter melts the fabric, generally severing the fabric. Where cutting is across pockets, the speed of the cutter can be adjusted such that layers 12A, 12B are cut without fusing together. However, in the case of sealing the end of a pocket, the speed of the cutter may be modified to melt and fuse end portions of layers 12A, 12B together such that the remaining selvage may be cleanly torn away leaving a closure 12D closing the end of the pocket.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A vertical blind comprising:
a woven or knitted single fabric sheet having a series of elongated vertical panels, the vertical panels including at least one elongated relatively translucent panel and a plurality of elongated vertical pocket panels, each pocket panel including an elongated pocket;
the translucent panel including a first group of knitted or woven yarns; at least one of the elongated pocket panels including a pair of spaced apart fabric layers and wherein the elongated pocket panel includes a second group of woven or knitted yarns;
the translucent panel coupled to at least one of the elongated pocket panels by woven or knitted yarns of the first and second groups;
an elongated vane disposed and contained within each of the pockets for moving the associated pocket panel between open and closed positions; and wherein the pocket panels along with the vanes form relatively opaque panels such that the vertical blind includes relatively translucent and relatively opaque panels.

2. The vertical blind of claim 1 wherein the relatively translucent panel is disposed between two relatively opaque panels.

3. The vertical blind of claim 1 wherein the relatively translucent panel is disposed between two pairs of relatively opaque panels.

4. The vertical blind of claim 3 wherein the relatively opaque panels of each pair are connected together by a hinge.

5. The vertical blind of claim 1 wherein an upper end portion of each pocket panel is configured to extend at least partially above an upper end portion of the vane contained therein such that the vane at least partially supports the fabric.

6. The vertical blind of claim 1 wherein the pockets are sufficiently open about a lower end portion thereof to enable the vanes to be inserted into the pockets.

7. The vertical blind of claim 6 wherein the pockets are at least partially closed about an upper end portion thereof such that the fabric is at least partially supported by the vanes.

8. The vertical blind of claim 1 including a support assembly having a frame and a plurality of hangers secured to the frame, and wherein the hangers are configured to attach to the vanes contained in the pockets and to support the vanes.

9. The vertical blind of claim 1 wherein the fabric comprises a series of separate segments, wherein each segment includes at least one relatively translucent panel and at least two pocket panels, and wherein the segments are configured to be suspended in side-by-side relationship.

10. A vertical blind comprising:
a. a single fabric sheet having a series of elongated vertical panels knitted or woven into the sheet;
b. the series of elongated vertical panels including at least one panel of at least one layer of fabric;
c. the series of elongated vertical panels further including a plurality of elongated vertical pocket panels each forming a vane pocket knitted or woven into the sheet and extending substantially from a top edge of the single fabric sheet to a bottom edge of the sheet;
d. wherein the one panel of at least one layer of fabric is disposed between two elongated vertical pocket panels; and
e. an elongated vane disposed and contained within each of the elongated vane pockets for moving the vane pockets between open and closed positions.

11. The vertical blind of claim 10 wherein the vertical pocket panels are relatively translucent or relatively opaque and wherein the one layer of fabric is relatively translucent or relatively opaque.

12. The vertical blind of claim 11 wherein the pocket panels are relatively translucent so as to at least partially expose the vanes in the pocket panels.

13. The vertical blind of claim 10 wherein upper end portions of the pocket panels are configured to extend at least partially above upper end portions of the vanes contained therein such that the vanes at least partially support the fabric; and wherein at least one panel is a non-pocket panel.

14. The vertical blind of claim 10 wherein the vane pockets are sufficiently open about a lower end portion thereof to enable the vanes to be inserted into the vane pockets.

15. (canceled)

16. The vertical blind of claim 10 including a support assembly having a frame and a plurality of hangers secured to the frame, and wherein the hangers are configured to attach to the vanes contained in the vane pockets and to support the vanes.

17. A method of manufacturing a vertical blind comprising:
a. forming a fabric sheet having a series of vertical panels within the sheet;
b. forming at least one panel of the series of panels as a relatively translucent panel;
c. forming at least two of the series of panels into elongated pocket panels where each elongated pocket panel forms an elongated pocket for receiving an elongated vane that moves the elongated pocket;
d. providing at least two elongated vanes, such that each elongated vane can be inserted into one of the elongated pockets such that each elongated pocket can be moved by moving the elongated vane;
e. wherein the elongated pocket and the elongated vane form a relatively opaque panel; and
f. wherein forming the relatively translucent panel includes weaving or knitting together at least a first group of yarns to form the translucent panel;
g. forming at least one pocket panel includes weaving or knitting at least a second group of yarns to form at least a portion of the elongated pocket panel; and
h. coupling the translucent panel to at least one of the pocket panels by weaving or knitting yarns from the first and second groups of yarns.

18. The method of claim 17 including providing each pocket panel with an open bottom end portion that is sufficiently open to enable a vane to be inserted into the vane pocket.

19. The method of claim 17 including at least partially closing upper end portions of the pocket panels such that the vanes at least partially support the blind.

20. The method of claim 19 wherein at least partially closing upper end portions of the pocket panels includes sealing together portions of first and second layers of the each pocket.

21. The method of claim 17 including cutting the fabric into segments, each segment including at least two pocket panels with a translucent panel disposed there between.

22. (canceled)

23. (canceled)

24. (canceled)

25. (canceled)

26. The vertical blind of claim 1 wherein the translucent panel comprises a single layer of fabric disposed adjacent at least one of the pocket panels; and at a juncture between the translucent panel and the pocket panel, the single layer of fabric of the translucent panel branches into the spaced apart fabric layers that form the pocket panel.

27. The vertical blind of claim 1 wherein each elongated pocket extends substantially from one edge of the single fabric sheet to an opposite edge of the sheet.

28. The vertical blind of claim 1 wherein the single fabric sheet is woven and wherein the first group of yarns includes a first weft yarn, and wherein the second group of yarns includes a second weft yarn.

29. The vertical blind of claim 28 wherein the first and second weft yarns have different deniers.

30. The vertical blind of claim 29 wherein the denier of the first weft yarn is less than the denier of the second weft yarn.

31. The vertical blind of claim 1 wherein the single fabric sheet is knitted and the first and second sets of yarns have different deniers.

32. The vertical blind of claim 31 wherein the denier of the first set of yarns is less than the denier of the second set of yarns.

33. The vertical blind of claim 10 wherein:
a. the single fabric sheet is of a woven or knitted construction including first and second groups of yarns;
b. the panel of at least one layer of fabric is a non-pocket panel formed in part at least by a first group of knitted or woven yarns;
c. at least one of the vertical pocket panels includes a pair of spaced apart fabric layers formed at least in part by a second group of woven or knitted yarns; and
d. the non-pocket panel is coupled to at least one of the vertical pocket panels by woven or knitted yarns of the first and second groups.

34. The vertical blind of claim 33 wherein the non-pocket panel lies adjacent at least one of the pocket panels; and wherein at a juncture between the non-pocket panel and the pocket panel, the single fabric sheet branches from a single layer of fabric that forms the non-pocket panel to the spaced apart fabric layers that form the pocket panel.

35. The vertical blind of claim 33 wherein:
a. the single fabric sheet is of a woven construction, the first group of yarns including a first weft yarn and the second group of yarns including a second weft yarn; and
b. the first weft yarn has a denier different from the second weft yarn.

36. The vertical blind of claim 35 wherein the denier of the first weft yarn is less than the denier of the second weft yarn.

37. The vertical blind of claim 33 wherein the single fabric sheet is of a knitted construction and the first and second groups of yarns have different deniers.

38. The method of claim 17 restricted to forming the single sheet fabric by weaving wherein the first group of yarns includes a first weft yarn and the second group of yarns includes a second weft yarn of a different denier than that of the first weft yarn.

39. The method of claim 17 restricted to forming the single fabric sheet by knitting wherein the first and second groups of yarns have different deniers.

40. A blind comprising:
a. a woven or knitted single fabric sheet formed into a blind;
b. the single fabric sheet including at least one elongated panel formed by at least two fabric layers woven or knitted in the single fabric sheet to form an elongated pocket;
c. the elongated pocket extending substantially from one edge of the blind to another edge of the blind;
d. the elongated pocket having a width less than the width of the single fabric sheet and the single fabric sheet includes at least one non-pocket area disposed adjacent the formed pocket;
e. wherein the non-pocket area is connected to the formed pocket by knitted or woven yarns; and
f. an elongated vane insertable within the pocket for moving the pocket.

41. The blind of claim 40 wherein the non-pocket area extends over a selected area of the single fabric sheet and the single fabric sheet branches into the two fabric layers at a juncture generally defined between the non-pocket area and the formed pocket.

42. The blind of claim 40 wherein the pocket is disposed adjacent the non-pocket area and wherein the fabric layers of the pocket is joined to the non-pocket area by knitted or woven connections.

43. A method of manufacturing a vertical blind, comprising:
a. forming a fabric blind by a knitting or weaving process;
b. as the fabric blind is being knitted or woven, forming a series of elongated panels in the fabric blind during the knitting or weaving process;
c. forming at least one elongated pocket panel in the fabric blind by knitting or weaving the elongated pocket panel into the fabric blind during the knitting or weaving process that forms the fabric blind; and
d. wherein the knitted or woven elongated pocket panel forms an elongated pocket for receiving an elongated vane.

44. The method of claim 43 including providing at least one elongated vane for insertion into the elongated pocket of the vertical blind.

45. The method of claim 43 including forming the elongated pocket panel by knitting or weaving two layers of fabric and coupling the two layers of fabric to the blind fabric by knitting or weaving during the knitting or weaving process that forms the fabric blind.

46. The method of claim 43 wherein the series of elongated panels include at least two elongated pocket panels and at least one elongated translucent panel.

47. The method of claim 43 wherein the series of elongated panels includes a plurality of elongated pocket panels and a plurality of elongated translucent panels, and wherein the method includes cutting the fabric blind into segments, each segment including at least two elongated pocket panels and at least one elongated translucent panel.

48. The method of claim 43 wherein at least one of the series of elongated panels is a single fabric layer non-pocket panel and wherein at least one of the series of elongated panels is a double fabric layer pocket panel; and wherein the method includes knitting or weaving at least one set of yarns to form the single fabric layer and knitting or weaving at least one other set of yarns to form at least a portion of the double fabric layer pocket panel.

49. The method of claim 48 wherein the method includes weaving one set of weft yarn to form at least a part of the single fabric layer non-pocket panel and weaving another set of weft yarns to form at least a part of the double fabric layer pocket panel; and wherein the deniers of the two sets of weft yarns are different.

50. The method of claim 48 including knitting the fabric blind and the non-pocket panel and the pocket panel by utilizing first and second groups of yarn.

51. The method of claim 43 wherein at least one of a series of elongated panels is a non-pocket panel and wherein at least one of the series of elongated panels is a pocket panel; and wherein the method includes continuously weaving or knitting the fabric blind across a juncture defined between the non-pocket panel and the pocket panel and at the juncture splitting the fabric blind into two knitted or woven layers that form the pocket panel on one side of the juncture.
